(19) United States
(12) Patent Application Publication
(10) Pub. No.: US 2021/0373283 A1
(43) Pub. Date: Dec. 2, 2021

(54) IMAGING LENS UNIT AND METHOD FOR MANUFACTURING THE SAME

(71) Applicant: KANTATSU CO., LTD., Yaita-shi (JP)

(72) Inventor: Nobuyuki KASAMA, Sukagawa-city (JP)

(21) Appl. No.: 17/344,651

(22) Filed: Jun. 10, 2021

Related U.S. Application Data
(63) Continuation of application No. 15/996,142, filed on Jun. 1, 2018, now abandoned.

(30) Foreign Application Priority Data
Jun. 2, 2017 (JP) 2017-110499
Apr. 27, 2018 (JP) 2018-086565

(51) Int. Cl. G02B 9/60; G02B 7/02

(52) U.S. Cl. CPC G02B 9/60; G02B 7/021

(57) ABSTRACT

An imaging lens unit capable of more effectively suppressing positional deviation of a lens element and a simple manufacturing method thereof. In the imaging lens unit 1, adjacent lens elements of a first lens element 10, a second lens element 20, a third lens element 30, a fourth lens element 40 and a fifth lens element 50, a lens barrel 2 and the first lens element 10, and the lens barrel 2 and the fifth lens element 50 are bonded at a surface modification portion formed by irradiation with vacuum ultraviolet light.

### TECHNICAL FIELD

The present invention relates to an imaging lens unit and a manufacturing method of an imaging lens unit.

### BACKGROUND ART

In the above technical field, in PTL 1, a technique is disclosed that relates to a plurality of imaging lenses and a tubular lens barrel that holds the imaging lenses, wherein the lens barrel includes a lens support portion for one side of the imaging lenses and a lens holding portion for another side of the imaging lenses, an outer end portion of a rear lens located on an imaging plane side includes a barrel insert ion port ion and a lens pressing port ion which is larger than an inner diameter of the lens holding portion and has an opposing surface at a location separated from an end surface of the lens holding portion, and adhesive is filled between the end face and the opposing face.

### CITATION LIST

### Patent Literature

PTL 1: JP 2011-53283 A

### SUMMARY OF INVENTION

### Technical Problem

However, as the imaging device disclosed in PTL 1 has a structure in which the lens holding portion of the lens barrel and the rear lens are bonded at the outer portion, manufacturing is extremely difficult. In addition, as the members housed inside the lens barrel are only held by the adhesion of the rear lens, positional deviation may occur in the internal structure when a thermal shock, physical shock, or the like is applied to the imaging device. In this case, there is a problem that the optical performance deteriorates and the image quality decreases.

The present invention is to provide a technique for solving the above-mentioned problems.

### Solution to Problem

In order to achieve the above objectives, the imaging lens unit according to the present invention relates to a configuration of an imaging lens unit including a lens barrel formed of a resin material and a plurality of lens elements formed of a resin material and housed in the lens barrel, wherein each of the plurality of lens elements includes a lens portion and an edge portion around the lens portion, a surface modification portion is formed by irradiation of vacuum ultraviolet light on the edge portion, and adjacent lens elements of the plurality of lens elements are bonded at the surface modification portion.

In order to achieve the above objectives, the imaging lens unit according to the present invention includes a configuration in which a surface modification portion is formed by irradiation of vacuum ultraviolet light on a receiving surface of the lens barrel orthogonal to the optical axis where the edge portion of the lens element of the plurality of lens elements disposed closest to an object side abuts and a cylindrical inner circumferential surface of the lens barrel extending in an optical axis direction, and the edge portion of the lens element of the plurality of lens elements disposed closest to the object side and the receiving surface of the lens barrel are bonded at the surface modification portions.

In order to achieve the above objectives, the imaging lens unit according to the present invention includes a configuration in which a surface modification portion is formed by irradiation of vacuum ultraviolet light on an outer circumferential surface of the edge portion of the lens element of the plurality of lens elements disposed closest to an image side, and the outer circumferential surface of the edge portion of the lens element of the plurality of lens elements disposed closest to an image side and the lens barrel are bonded together by press fitting.

In order to achieve the above objectives, the imaging lens unit according to the present invention includes a configuration including, closest to an image side of the lens barrel, an annular fixing member formed of a resin material for fixing a plurality of lens elements, wherein a surface modification portion is formed by irradiating vacuum ultraviolet light on an outer circumferential surface of the annular fixing member, and the surface modification portion formed on the outer circumferential surface of the annular fixing member and the surface modification portion formed on the lens barrel are pressurized and bonded by press fitting.

In order to achieve the above objectives, a method of manufacturing the imaging lens unit according to the present invention relates to a method of manufacturing an imaging lens unit that includes a lens barrel made of a resin material, and a plurality of lens elements formed of a resin material housed in the lens barrel, each of the plurality of lens elements including a lens portion and an edge portion surrounding the ledge portion, the method including a surface modification step of irradiating vacuum ultraviolet light on the edge portions of the plurality of lens element to form surface modification portions and a bonding step of pressing together the surface modification portions to bond the lens elements to each other.

In order to achieve the above objectives, the method of manufacturing the imaging lens unit according to the present invention includes a surface modification step of irradiating vacuum ultraviolet light to form a surface modification portion on a receiving surface of the lens barrel orthogonal to the optical axis where the edge portion of the lens element of the plurality of lens elements disposed closest to an object side abuts and a cylindrical inner circumferential surface of the lens barrel extending in an optical axis direction, and bonding step of pressing and bonding the surface modification portions of the edge portion of the lens elements and the lens barrel.

In order to achieve the above objectives, the method of manufacturing the imaging lens unit according to the present invention includes a surface modification step of forming a surface modification portion by irradiation of vacuum ultraviolet light on an outer circumferential surface of the edge portion of the lens element of the plurality of lens elements disposed closest to the image side, and a bonding step of pressing and bonding the outer circumferential surface of the edge portion of the lens element of the plurality of lens elements disposed closest to the image side to the inner circumferential surface of the lens barrel by press fitting.

In order to achieve the above objectives, the method of manufacturing the imaging lens unit according to the present invention relates to an imaging lens unit further including, closest to the image side of the lens barrel, an annular fixing member formed of a resin material for fixing a plurality of lens elements, the method further including a surface modification step of forming, by irradiating vacuum ultraviolet light on an outer circumferential surface of the annular fixing member, a surface modification portion, and a bonding step of pressing and bonding the annular fixing member inside the lens barrel by press fitting.

In order to achieve the above objectives, the method of manufacturing the imaging lens unit according to the present invention includes, before or after the above-mentioned surface modification step by vacuum ultraviolet radiation, or during the bonding step, a heating step of heating the surface modification portion.

### Advantageous Effects of Invention

According to the present invention, it is possible to bond members by compressing surface modification portions formed by irradiation from vacuum ultraviolet rays. Accordingly, it is possible to obtain an imaging lens unit that is easy to assemble and is resistant to thermal shocks and physical shocks without using adhesives or the like.

### BRIEF DESCRIPTION OF DRAWINGS

FIG. 1 is a cross-sectional view of an imaging lens unit according to a first embodiment of the present invention.

FIGS. 2A and 2B are diagrams illustrating a lens barrel of the imaging lens unit of FIG. 1.

FIG. 3 is an exploded view of a lens assembly of the imaging lens unit of FIG. 1.

FIG. 4 is a cross-sectional view illustrating a coating region and a non-coating region of a lens element.

FIGS. 5A to 5D are diagrams for explaining a manufacturing method of the imaging lens unit of FIG. 1.

FIGS. 6A to 6D are diagrams for explaining the manufacturing method of the imaging lens unit of FIG. 1, continuing from FIGS. 5A to 5D.

FIGS. 7A and 7B are diagrams for explaining the manufacturing method of the imaging lens unit of FIG. 1, continuing from FIGS. 6A to 6D.

FIG. 8 is a cross-sectional view of an imaging lens unit according to a second embodiment of the present invention.

FIG. 9 is a cross-sectional view of a lens barrel and an annular fixing member of the imaging lens unit of FIG. 8.

FIGS. 10A to 10D are diagrams for explaining a manufacturing method of the imaging lens unit of FIG. 8.

FIGS. 11A and 11B are diagrams for explaining the manufacturing method of the imaging lens unit of FIG. 8, continuing from FIGS. 10A to 10D.

### DESCRIPTION OF EMBODIMENTS

Hereinafter, embodiments for carrying out the present invention will be described in detail by way of example with reference to the drawings. However, the configurations described in the following embodiments are merely examples, and variations and modifications thereof are freely allowed and do not intend to limit the technical scope of the present invention to the following description.

### First Embodiment

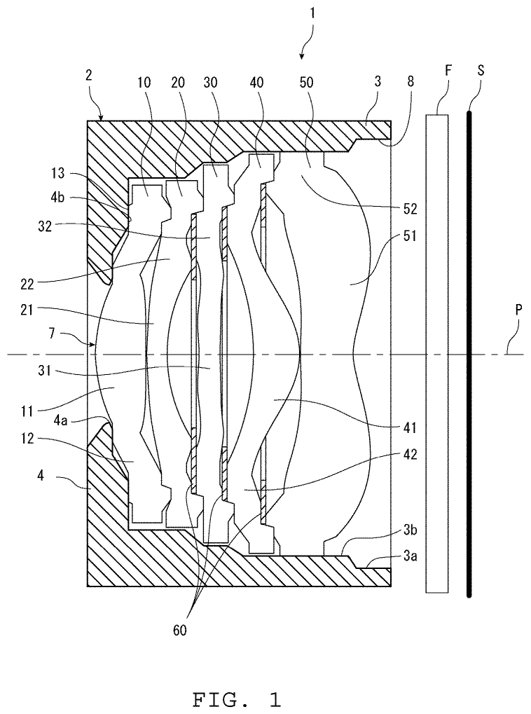

An imaging lens unit according to a first embodiment of the present invention will be described with reference to FIG. 1 to FIGS. 7A and 7B.

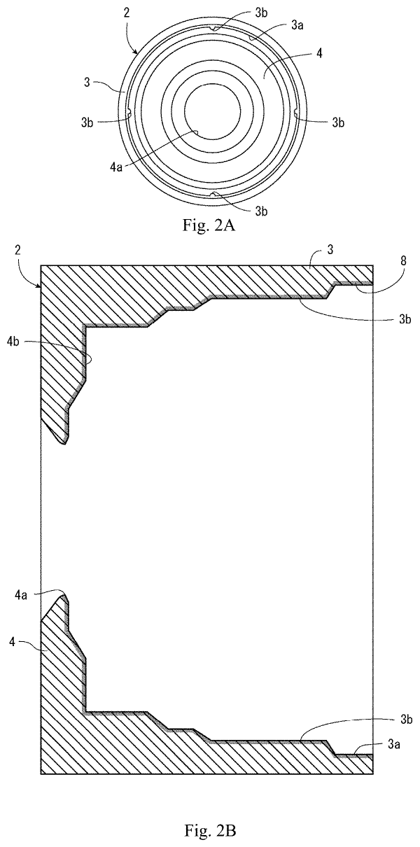

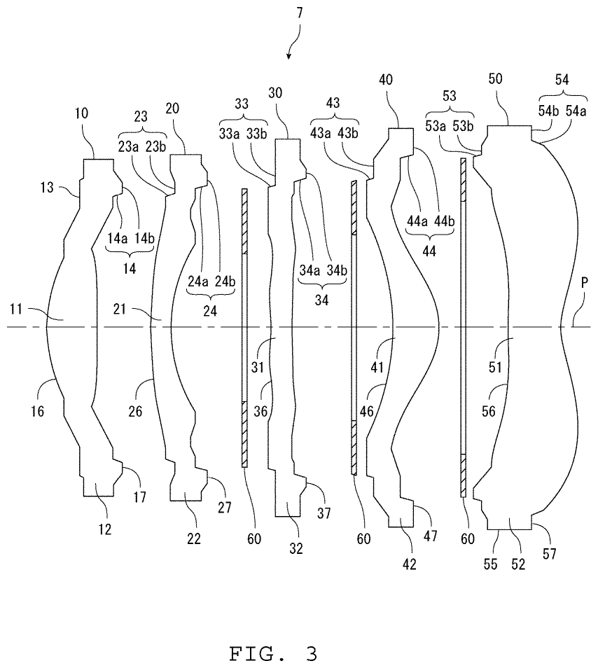

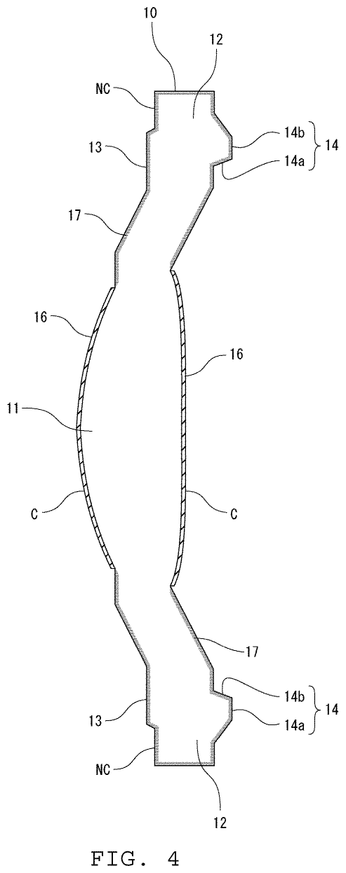

FIG. 1 is a cross-sectional view illustrating the entire configuration of an imaging lens unit according to the present embodiment. FIGS. 2A and 2B are diagrams illustrating the lens barrel of the imaging lens unit of FIG. 1. FIG. 2A is a view as seen from behind, and FIG. 2B is a cross-sectional view. FIG. 3 is an exploded view of the lens assembly of the imaging lens unit of FIG. 1. FIG. 4 is a cross-sectional view illustrating a coating region and a non-coating region of the lens element. It should be noted that in the following description, the left side of FIG. 1 and FIG. 3 is defined as the front side (or the object side), and the right side is defined as the rear side (or the image side).

As illustrated in FIG. 1, the imaging lens unit 1 of the present embodiment is provided in the camera of a portable information terminal, for example, and is used in combination with an imaging sensor S and an infrared cut filter F.

The imaging lens unit 1 includes a lens barrel 2 and a lens assembly 7 housed in the lens barrel 2.

The lens barrel 2 is formed of a black, non-translucent resin such as a polycarbonate to which carbon has been added, for example.

The lens barrel 2 is constituted by a cylindrical peripheral wall portion 3 having front and rear openings and a front wall portion 4 having an opening 4a at its center. A receiving surface 4b of the lens element is formed behind the front wall portion 4. The receiving surface 4b is formed so as to be perpendicular to the optical axis P. In addition, a first lens element 10 to be described later is in contact with the receiving surface 4b. As illustrated in FIG. 2A, a plurality of ribs 3b extending in the front and rear directions are formed on the inner circumferential surface 3a of the peripheral wall portion 3.

As illustrated in FIG. 2B, a surface modification portion 8 is formed on the inner surface of the lens barrel 2. The surface modification portion 8 is formed by irradiation of vacuum ultraviolet light (VUV light) having a wavelength of approximately 100 nm to 200 nm.

It should be noted that the surface modification described herein refers to formation of a polar functional group (—OH, —CHO, —COOH) on the surface of the resin as a result of excitation of oxygen molecules in the atmosphere and promotion of an oxidation reaction by irradiation with vacuum ultraviolet light.

In this way, the surface of the resin is modified from hydrophobic to hydrophilic, resulting in adhesion. By applying such a treatment to two resin surfaces and bringing the treated surfaces into contact with each other, it becomes possible to bond them.

With respect to the lens element to be described later, as well, the same surface modification portion is formed on the edge portion.

It should be noted that, the principle of the adhesiveness of such surface modification is described in academic papers regarding vacuum ultraviolet light (“Atmospheric Pressure Surface Modification of Polymer Material by Vacuum Ultraviolet Light”, Hiroyuki Sugimura, Surface Technology Vol. 63 (2012) No. 12) and the like, for example, and the explanation thereof is omitted in the present specification.

The lens assembly 7 housed in the imaging lens unit 1 includes, in order from the front to the rear, five lenses including a first lens element 10, a second lens element 20, a third lens element 30, a fourth lens element 40, and a fifth lens element 50.

A light shielding plate 60 is arranged between the second lens element 20 and the third lens element 30, between the third lens element 30 and the fourth lens element 40, and between the fourth lens element 40 and the fifth lens element 50.

In the present embodiment, the material of all the lens elements is made of resin. The type of resin, for example, is polycarbonate (PC), cycloolefin polymer (COP), cycloolefin copolymer (COC), polymethyl methacrylate (PMMA) or the like.

As illustrated in FIG. 4, with respect to the first lens element 10, an anti-reflection film 16 made of an inorganic material such as silicon oxide (SiO₂), titanium oxide (TiO₂), or a composite material thereof is formed on the entire surface of the lens portion 11 (that is, on the entire object side surface and the image side surface).

In addition, a surface modification portion 17 is formed on the entire surface of the edge portion 12 surrounding the lens portion 11 by irradiation with vacuum ultraviolet light. Similarly to the other lens elements, an anti-reflection film is formed on the lens portion, and a surface modification portion is formed on the edge portion.

As illustrated in FIG. 3, the first lens element 10 includes a lens portion 11 having a convex surface on both the object side and the image side, and an edge portion 12 located surrounding the lens portion 11.

On the object side of the edge portion 12, a contact surface 13 that abuts the receiving surface 4b of the lens barrel 2 is formed. The contact surface 13 is formed so as to be perpendicular to the optical axis P.

An annular step portion 14 is formed on the image side of the edge portion 12. The annular step portion 14 is constituted by an inward-facing conical inclined surface 14a centered on the optical axis P and a ring plane 14b connecting to the outside from the end portion of the conical inclined surface 14a.

The second lens element 20 is disposed on the image side of the first lens element 10. The second lens element 20 includes a lens portion 21 having a convex surface on the object side and a concave surface on the image side, and an edge portion 22 located surrounding the lens portion 21.

On the object side of the edge portion 22, an annular step portion 23 is formed. The annular step portion 23 is constituted by an outward-facing conical inclined surface 23a centered on the optical axis P and a ring plane 23b connecting to the outside from the end portion of the conical inclined surface 23a.

An annular step portion 24 is formed on the image side of the edge portion 22. The annular step portion 24 is constituted by an inward-facing conical inclined surface 24a centered on the optical axis P and a ring plane 24b connecting to the outside from the end portion of the conical inclined surface 24a.

The conical inclined surface 23a of the second lens element 20 abuts the conical inclined surface 14a of the first lens element 10. In this way, the center of the first lens element 10 and the center of the second lens element 20 align on the optical axis P.

In addition, the ring plane 23b of the second lens element 20 abuts the ring plane 14b of the first lens element 10. In this way, the interval between the first lens element 10 and the second lens element 20 in the direction of the optical axis P is determined.

The surface modification portion 17 formed on the annular step portion 14 of the first lens element 10, and the surface modification portion 27 formed on the annular step portion 23 of the second lens element 20 are bonded by abutting against one another.

The third lens element 30 is disposed on the image side of the second lens element 20. The third lens element 30 includes a lens portion 31 formed such that the object side and the image side are concave surfaces near the optical axis, both sides are aspherical surfaces, and an edge portion 32 is located surrounding the lens portion 31.

An annular step portion 33 is formed on the object side of the edge portion 32. The annular step portion 33 is constituted by an outward-facing conical inclined surface 33a centered on the optical axis P and a ring plane 33b connecting to the outside from the end portion of the conical inclined surface 33a.

An annular step portion 34 is formed on the image side of the edge portion 32. The annular step portion 34 is constituted by an inward-facing conical inclined surface 34a centered on the optical axis P and a ring plane 34b connecting to the outside from the end portion of the conical inclined surface 34a.

The conical inclined surface 33a of the third lens element 30 abuts the conical inclined surface 24a of the second lens element 20. In this way, the centers of the second lens element 20 and the third lens element 30 align on the optical axis P.

In addition, the ring plane 33b of the third lens element 30 abuts the ring plane 24b of the second lens element 20. In this way, the interval between the second lens element 20 and the third lens element 30 in the direction of the optical axis P is determined.

The surface modification portion 27 formed on the annular step portion 24 of the second lens element 20, and the surface modification portion 37 formed on the annular step portion 33 of the third lens element 30 are bonded by abutting against one another.

The fourth lens element 40 is disposed on the image side of the third lens element 30. The fourth lens element 40 includes a lens portion 41 having a concave surface on the object side and a convex surface on the image side, and an edge portion 42 located surrounding the lens portion 41.

An annular step portion 43 is formed on the object side of the edge portion 42. The annular step portion 43 is constituted by an outward-facing conical inclined surface 43a centered on the optical axis P and a ring plane 43b connecting to the outside from the end portion of the conical inclined surface 43a.

An annular step portion 44 is formed on the image side of the edge portion 42. The annular step portion 44 is constituted by an inward-facing conical inclined surface 44a centered on the optical axis P and a ring plane 44b connecting to the outside from the end portion of the conical inclined surface 44a.

The conical inclined surface 43a of the fourth lens element 40 abuts the conical inclined surface 34a of the third lens element 30. In this way, the centers of the third lens element 30 and the fourth lens element 40 align on the optical axis P.

In addition, the ring plane 43b of the fourth lens element 40 abuts the ring plane 34b of the third lens element 30. In this way, the interval between the third lens element 30 and the fourth lens element 40 in the direction of the optical axis P is determined.

In addition, the surface modification portion 37 formed on the annular step portion 34 of the third lens element 30, and the surface modification portion 47 formed on the annular step portion 43 of the fourth lens element 40 are bonded by abutting against one another.

The fifth lens element 50 is disposed on the image side of the fourth lens element 40. The fifth lens element 50 includes a lens portion 51 formed such that the object side has a convex surface and the image side has a concave surface near the optical axis, both sides are aspherical surfaces, and an edge portion 52 is located surrounding the lens portion 51.

An annular step portion 53 is formed on the object side of the edge portion 52. The annular step portion 53 is constituted by an outward-facing conical inclined surface 53a centered on the optical axis P and a ring plane 53b connecting to the outside from the end portion of the conical inclined surface 53a.

An annular step portion 54 is formed on the image side of the edge portion 52. The annular step portion 54 is constituted by an outward-facing conical inclined surface 54a centered on the optical axis P and a ring plane 54b connecting to the outside from the end portion of the conical inclined surface 54a.

The conical inclined surface 53a of the fifth lens element 50 abuts the conical inclined surface 44a of the fourth lens element 40. In this way, the centers of the fourth lens element 40 and the fifth lens element 50 align on the optical axis P.

In addition, the ring plane 53b of the fifth lens element 50 abuts the ring plane 44b of the fourth lens element 40. In this way, the interval between the fourth lens element 40 and the fifth lens element 50 in the direction of the optical axis P is determined.

In addition, the surface modification portion 47 formed on the annular step portion 44 of the fourth lens element 40, and the surface modification portion 57 formed on the annular step portion 53 of the fifth lens element 50 are bonded by abutting against one another.

In this way, the lens assembly 7 is completed. It should be noted that the bonding strength of each surface modification portion is enhanced by pressing the surface modification portions together.

The imaging lens unit is completed by inserting the lens assembly 7 into the lens barrel 2.

Here, as illustrated in FIG. 2A, a plurality of ribs 3b convex toward the inside are provided on the inner circumferential surface 3a of the peripheral wall portion 3 of the lens barrel 2. The diameter of an imaginary circle formed by connecting the tips of these ribs 3b is slightly smaller than the diameter of the outer diameter of the fifth lens element 50.

That is, the outer circumferential surface 55 of the fifth lens element 50 and the plurality of ribs 3b of the lens barrel 2 are pressed together in a press-fit state.

The pressed portions bond to each other because both were surface modified in advance.

The step of inserting the lens assembly 7 ends when the contact surface 13 provided at the edge portion of the first lens element 10 comes into contact with the receiving surface 4b of the lens barrel 2.

Accordingly, the surface modification portion 8 formed on the receiving surface 4b of the lens barrel 2 and the surface modification portion 17 formed on the contact surface 13 of the first lens element 10 are also bonded to each other.

It should be noted that, although the above embodiments described an example in which ribs 3b were provided on the inner circumferential surface 3a of the lens barrel 2, a configuration may be used in which the ribs 3b of the lens barrel 2 are not included and a plurality of ribs are formed on the outer circumferential surface 55 of the fifth lens element 50. Also, configurations in which ribs are provided on both, and configurations in which ribs are not provided on either are also possible.

In addition, as illustrated in FIG. 4, the entire surface of the lens element 11 of the first lens element 10 in the present embodiment is a coating region C on which the anti-reflection film 16 is formed, and the entire surface of the edge portion 12 is a non-coating region NC without the anti-reflection film 16.

The surface modification portion 17 is applied to the non-coating region NC. It should be noted that the surface modification portion need not be formed on the entire surface of the edge portion, but may be formed at the contact portion with the bonding component. The same applies to the lens elements 20, 30, 40, and 50.

The plurality of light shielding plates 60 are flat annular members formed of a non-translucent resin, a sheet material that has undergone a light shielding treatment, or a thin metal plate. The light shielding plate 60 is used for shielding unnecessary light and suppressing occurrence of ghosting and flares.

In the present embodiment, one light shielding plate 60 is arranged between the second lens element 20 and the third lens element 30, between the third lens element 30 and the fourth lens element 40, and between the fourth lens element 40 and the fifth lens element 50.

With respect to the location where the light shielding plates 60 are arranged, it is not necessary to arrange one at all the positions described above unless there is a need to shield light. In addition, when necessary, a light shielding plate 60 may be arranged between the first lens element 10 and the second lens element 20.

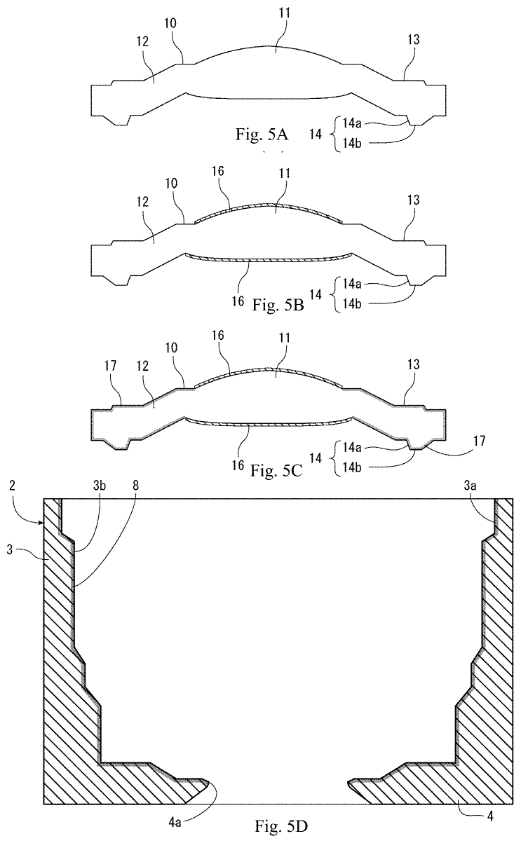

Next, an example of the manufacturing process of the above-described imaging lens unit 1 will be described primarily with reference to FIGS. 5A to 5D to FIGS. 7A and 7B.

FIGS. 5A to 5D are diagrams for explaining a manufacturing method of the imaging lens unit 1 of FIG. 1 and illustrate a process of applying a surface treatment to the lens element 10 and the lens barrel 2.

FIG. 5A illustrates the lens element 10 prior to surface processing. FIG. 5B illustrates the lens element 10 on which the anti-reflection film 16 is formed. FIG. 5C illustrates the lens element 10 on which the surface modification portion 17 is formed. FIG. 5D illustrates the lens barrel 2 on which the surface modification portion 8 is formed.

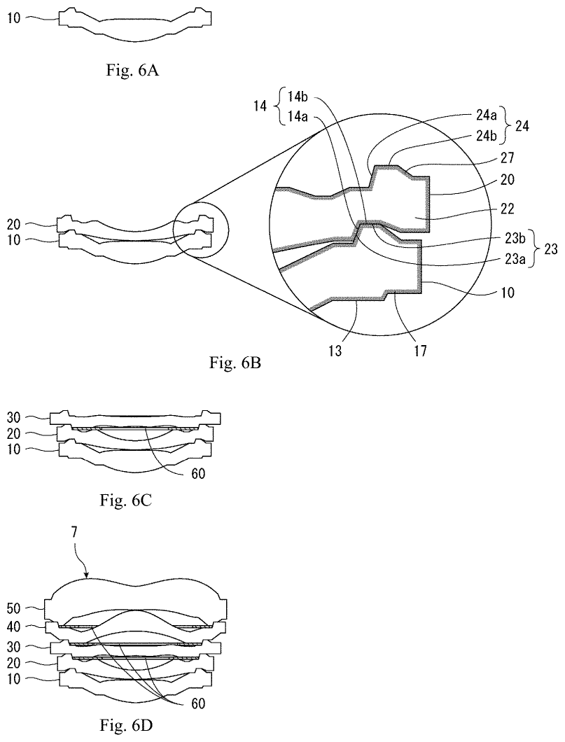

FIGS. 6A to 6D are diagrams for explaining the manufacturing method of the imaging lens unit 1 in FIG. 1 and illustrate the assembly process of the lens assembly 7.

FIG. 6A illustrates the first lens element 10. FIG. 6B illustrates a state in which the second lens element 20 is overlaid on the first lens element 10. FIG. 6C illustrates a state in which the light shielding plate 60 and the third lens element 30 are overlaid on the second lens element 20. FIG. 6D illustrates a completed view of the lens assembly 7 in which the light shielding plate 60, the fourth lens element 40, and the fifth lens element 50 are overlaid on the third lens element 30.

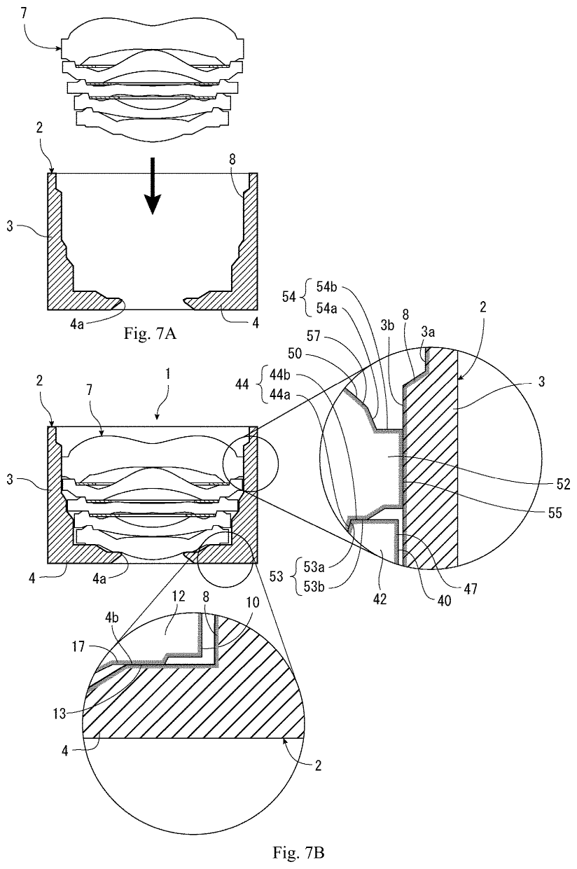

FIGS. 7A and 7B are diagrams for explaining the manufacturing method of the imaging lens unit 1 in FIG. 1, continuing from FIGS. 6A to 6D, and illustrate the assembly process of the imaging lens unit.

FIG. 7A illustrates how the lens assembly 7 is inserted into the lens barrel 2. FIG. 7B illustrates a state in which the imaging lens unit 1 is completed.

A detailed manufacturing method will be described below.

The first lens element 10 is obtained by injection molding (not depicted) of a resin material (FIG. 5A).

Next, an inorganic material is deposited on the lens portion 11 of the first lens element 10, and an anti-reflection film 16 is formed on the entire surface of the lens portion 11 (FIG. 5B).

This step is performed by a vacuum evaporation method, for example, in a state where a plurality of the lens portions 11 of the first lens element 10 are aligned in a jig that only exposes the lens portions 11. Next, a coating region C is formed on the entire surface of the lens portion 11.

As the edge portion 12 is covered by the jig, it becomes a non-coating region NC.

Next, vacuum ultraviolet light is irradiated on the entire surface of the lens element 10 that was removed from the jig. In this way, the surface modification portion 17 is formed in the non-coating region NC (FIG. 5C).

In this surface modification process, even when the entire lens is irradiated with vacuum ultraviolet light, as the anti-reflection film 16 formed on the lens portion 11 is an inorganic material, its surface is not modified. Accordingly, this does not cause any change in the optical characteristics.

It should be noted that, although FIG. 5A to FIG. 5C illustrate the process for the first lens element 10, anti-reflection films and surface modification portions are also formed for the other lens elements by the same process.

Further, vacuum ultraviolet light is irradiated to the inner surface of the lens barrel 2 to form the surface modification portion 8 on the inner surface of the lens barrel 2 (FIG. 5D).

Next, the first lens element 10 is installed in an assembly jig (not depicted) with its object side surface facing downward (FIG. 6A). Next, the second lens element 20 is overlaid on the image side of the first lens element 10 (FIG. 6B).

In this way, the conical inclined surface 23a of the second lens element 20 abuts the conical inclined surface 14a of the first lens element 10, and the ring plane 23b of the second lens element 20 abuts the ring plane 14b of the first lens element 10.

Subsequently, by pressing the edge portion 22 of the second lens element 20 toward the first lens element 10, the centers thereof align with each other, and they are bonded to each other at a predetermined interval. The applied pressure at this time is approximately 1 MPa, for example.

Similarly, after overlaying the light shielding plate 60 on the image side of the second lens element 20, the third lens element 30 is overlaid (FIG. 6C).

In this way, the conical inclined surface 33a of the third lens element 30 abuts the conical inclined surface 24a of the second lens element 20, and the ring plane 33b of the third lens element 30 abuts the ring plane 24b of the second lens element 20.

Subsequently, by pressing the edge portion 32 of the third lens element 30 toward the second lens element 20, the centers thereof align with each other, and they are bonded to each other at a predetermined interval. The applied pressure at this time is approximately 1 MPa, for example.

By repeatedly performing the above process up to the fifth lens element 50, the centers of the lens elements 10, 20, 30, 40, and 50 align with each other, they are bonded to each other at a predetermined interval, and the lens assembly 7 is completed (FIG. 6D).

It should be noted that when the lens assembly 7 completed in this manner is subjected to the heating step that will be described later, the bonding of the surface modification portion becomes stronger.

Next, as illustrated in FIG. 7A, the lens assembly 7 is inserted from the opening at the rear end of the lens barrel 2. Here, as the diameter of the imaginary circle connecting the tips of the plurality of ribs 3b on the inner circumferential surface 3a of the lens barrel 2 is slightly smaller than the diameter of the outer circumferential surface 55 of the fifth lens element 50, press fitting is used in the assembly.

This press fitting process is performed by pushing in the ring plane 54b of the edge portion 52 of the fifth lens element 50 with a jig (not depicted).

It should be noted that, as the center of the inner diameter of the lens barrel 2 and the center of the outer diameter of the fifth lens element 50 are designed so as to align with the optical axis P, the lens assembly 7 and the center of the lens barrel 2 are assembled in a state in which their centers coincide.

The press fitting process is completed when the first lens element 10 comes into contact with the receiving surface 4b of the front wall portion 4 of the lens barrel 2.

That is, the surface modification portion 57 formed on the outer circumferential surface 55 of the fifth lens element 50, and the surface modification portion 8 formed on the plurality of ribs 3b of the lens barrel 2 are pressed and bonded to each other.

Further, the surface modification portion 17 formed on the contact surface 13 of the first lens element 10 and the surface modification portion 8 formed on the receiving surface 4b of the lens barrel 2 are bonded to each other by the applied pressure of the insertion. The applied pressure at this time is approximately 1 MPa, for example.

By heating the imaging lens unit 1 assembled in this way to 30° C. to 120° C., or preferably 80° C. to 100° C., it is possible to further strengthen the bonding force of the surface modification portion.

It should be noted that the above process is based on the steps of surface modification—pressing—assembly—heating, but an order of heating—surface modification—pressing—assembly, an order of surface modification—heating—pressing—assembly, or an order of surface modification—simultaneous heating and pressing—assembly are also possible.

As described above, according to the imaging lens unit 1 of the present embodiment, the lens elements 10, 20, 30, 40 and 50, the lens elements adjacent to each of these, the lens barrel 2 and the first lens element 10, and the lens barrel 2 and the fifth lens element 50 are bonded at the surface modification portion formed by irradiation with vacuum ultraviolet light.

Accordingly, an adhesion step is unnecessary, and manufacturing is simplified. In addition, as all the members are bonded to each other, the structural strength is improved. Accordingly, it is possible to prevent positional deviation of the internal structure resulting from thermal shocks or physical shocks.

### Second Embodiment

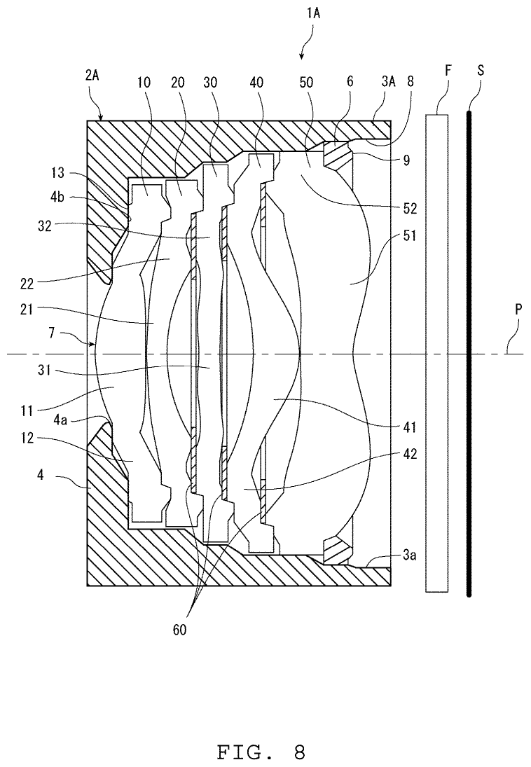

An imaging lens unit according to a second embodiment of the present invention will be described primarily with reference to FIG. 8 to FIGS. 11A and 11B.

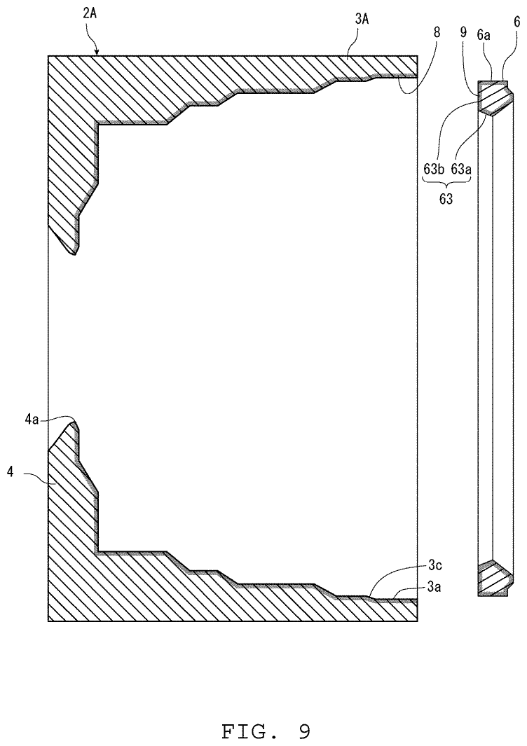

FIG. 8 is a cross-sectional view of the imaging lens unit 1A according to the second embodiment of the present invention. FIG. 9 is a cross-sectional view of the lens barrel 2A included in the imaging lens unit 1A in FIG. 8 and a rear light shielding ring 6 that serves as an annular fixing member. It should be noted that, in the following description, the left side of FIG. 8 is defined as the front side (or the object side), and the right side is defined as the rear side (or the image side).

Similarly to the first embodiment, the imaging lens unit 1A of the second embodiment illustrated in FIG. 8 is provided in a camera of a portable information terminal, for example, and is used in combination with an imaging sensor S and an infrared cutoff filter F.

The imaging lens unit 1A is constituted by a lens barrel 2A, a lens assembly 7 housed in the lens barrel 2A, and a rear light shielding ring 6 for fixing the lens assembly 7 from behind. It should be noted that, in the present embodiment, the same reference numerals are given to the same constituent elements as those of the first embodiment described above, and a detailed description thereof will be omitted herein.

In addition, the lens assembly 7 of the present embodiment is an example in which a surface modification portion is not formed in the edge portion of each lens, and otherwise the configuration is the same as in the first embodiment.

The lens barrel 2A is an example in which ribs are not formed on the inner circumferential surface 3a of the peripheral wall portion 3A, and otherwise the configuration is the same as the first embodiment in which the surface modification was formed.

The rear light shielding ring 6 is formed of a resin having non-translucent properties, such as a polycarbonate to which carbon has been added, for example. The rear light shielding ring 6 is inserted from the rear portion of the lens barrel 2A to fix the lens assembly 7 housed in the lens barrel 2A.

An annular corner portion 63 is formed on the object side of the rear light shielding ring 6. In the annular corner portion 63, an inward-facing conical inclined surface 63a centered on the optical axis P and a ring plane 63b connecting to the outside from the object side end portion of the conical inclined surface 63a are formed. In addition, a surface modification portion 9 is formed on the entire surface of the rear light shielding ring 6 by irradiation with vacuum ultraviolet light.

When the rear light shielding ring 6 is inserted from the image side of the lens barrel 2A, the conical inclined surface 63a is brought into contact with the conical inclined surface 54a of the fifth lens element 50. In this way, the centers of the fifth lens element 50 and the rear light shielding ring 6 align on the optical axis P. Further, the ring plane 63b abuts the ring plane 54b of the fifth lens element 50.

Further, the diameter of the outer circumferential surface 6a of the rear light shielding ring 6 is slightly larger than the diameter of the inner circumferential surface 3c of the lens barrel 2A. That is, the lens barrel 2A and the rear light shielding ring 6 have a press-fitted structure. Accordingly, when the rear light shielding ring 6 is inserted into the lens barrel 2A, the outer circumferential surface 6a of the rear light shielding ring 6 and the inner circumferential surface 3c of the lens barrel 2A are pressed together, and the surface modification portions are bonded to each other by the applied pressure.

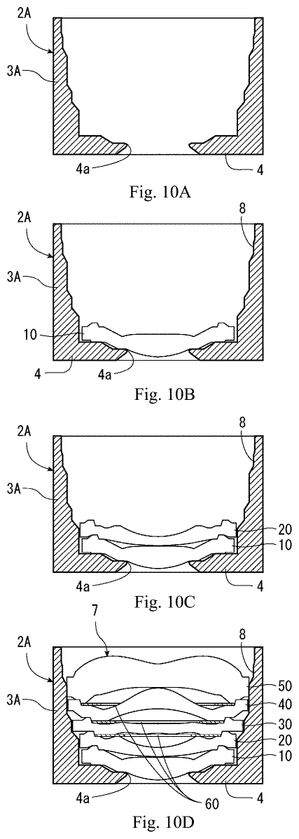

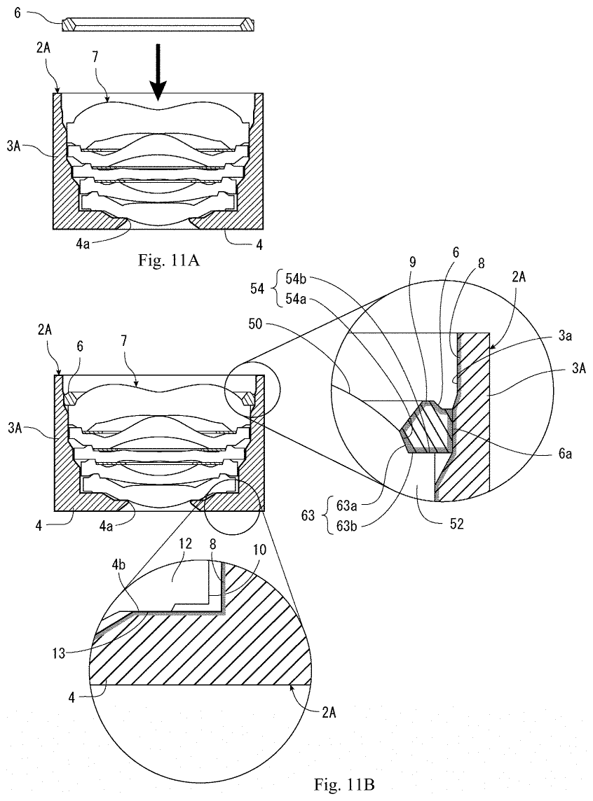

Next, an example of the manufacturing method of the above-described imaging lens unit 1A will be described with reference to FIGS. 10A to 10D and FIGS. 11A and 11B.

FIGS. 10A to 10D are diagrams for explaining the manufacturing method of the imaging lens unit 1A in FIG. 8. FIG. 10A illustrates the lens barrel prior to surface processing. FIG. 10B illustrates a state in which a first lens element 10 is housed in the lens barrel 2A. FIG. 10C illustrates a state in which a second lens element 20 is further housed in the lens barrel 2A. FIG. 10D illustrates a state in which a light shielding plate 60, a third lens element 30, a light shielding plate 60, a fourth lens element 40, a light shielding plate 60, and a fifth lens element 50 are sequentially housed.

FIGS. 11A and 11B are diagrams for explaining the manufacturing method of the imaging lens unit 1A in FIG. 8, continuing from FIGS. 10A to 10D. FIG. 11A illustrates how the rear light shielding ring 6 is inserted into the lens barrel 2A. FIG. 11B illustrates a state in which the imaging lens unit is completed.

The first lens element 10 is housed in the lens barrel 2A with its object side surface facing downward (FIG. 10B). In this way, the contact surface 13 of the first lens element 10 abuts the receiving surface 4b of the front wall portion 4 of the lens barrel 2A.

Next, when the second lens element 20 is overlaid on the image side of the first lens element 10 (FIG. 10C), the conical inclined surface 23a of the second lens element 20 abuts the conical inclined surface 14a of the first lens element 10.

In this way, the center of the first lens element 10 and the center of the second lens element 20 align on the optical axis P.

In addition, the ring plane 23b of the second lens element 20 abuts the ring plane 14b of the first lens element 10.

In this way, the interval between the first lens element 10 and the second lens element 20 in the direction of the optical axis P is determined.

Next, a light shielding plate 60, the third lens element 30, a light shielding plate 60, the fourth lens element 40, a light shielding plate 60, and the fifth lens element 50 are sequentially housed in the lens barrel 2A and overlaid (FIG. 10D).

The conical inclined surface formed on each lens element and the ring plane abut each other, such that the centers of the first lens element 10 to the fifth lens element 50 are positioned on the optical axis P and each interval is determined.

Next, the rear light shielding ring 6 is inserted from the rear end opening of the lens barrel 2A using an insertion jig (not depicted) (FIG. 11A).

As the diameter of the outer circumferential surface 6a of the rear light shielding ring 6 is slightly larger than the diameter of the inner circumferential surface 3c of the lens barrel 2A, this insertion is performed by press fitting. The press fitting process is completed when the ring plane 63b of the rear light shielding ring 6 comes into contact with the ring plane 54b of the fifth lens element 50 (FIG. 11B).

That is, the surface modification portion 9 formed on the outer circumferential surface 6a of the rear light shielding ring 6 and the surface modification portion 8 formed on the inner circumferential surface 3a of the lens barrel 2A are bonded to each other by the applied pressure of press fitting. The applied pressure at this time is approximately 1 MPa, for example.

By heating the imaging lens unit 1A assembled in this way to 30° C. to 120° C., or preferably 80° C. to 100° C., it is possible to further strengthen the bonding force of the surface modification portion.

It should be noted that in the above process, although the step of heating the imaging lens unit 1A is performed after assembling, the lens barrel 2A and the rear light shielding ring 6 may be heated before surface modification, or may be heated after surface modification. Further, heating may be performed when the rear light shielding ring 6 is inserted into the lens barrel 2A.

As described above, according to the imaging lens unit 1A of the present embodiment, as the lens barrel 2A and the rear light shielding ring 6 are bonded at each surface modification portion, fixing with adhesives or the like is unnecessary.

It should be noted that, in the present embodiment, the lens assembly 7 housed in the lens barrel 2A is an example in which a bonding process between the lenses is not performed. However, as the conical inclined surfaces formed on the edge portions of each lens element abut each other, the centers of each lens align on the optical axis P. In addition, as the ring planes abut each other, the interval between each lens is determined, and positioning is performed in the optical axis P direction. By bonding the rear light shielding ring 6 to the lens barrel 2A, this structure can be maintained.

It should be noted that, when necessary, a surface modification portion may be formed on the lens elements, and the surface modification portions may be partially bonded.

In addition, although an example of the lens assembly having five lens elements was illustrated in each of the above-described embodiments, the present invention is applicable as long as it is a lens assembly having two or more lens elements, or an imaging lens unit having a lens barrel and one lens element.

It should be noted that, in the imaging lens units according to each of the embodiments described above, although the surface modification portion 8 is formed on the entire inner surface of the lens barrel 2, the present invention is not limited thereto. For example, a configuration is also possible in which the surface modification portion 8 is only formed at the locations where the lens elements 10, 50 or the rear light shielding ring 6 are bonded. It is sufficient for the surface modification portion of the lens barrel to be formed at least at the locations where lens elements or the rear light shielding ring are coupled.

In addition, although the imaging lens unit of the second embodiment described above had a configuration in which the lens elements were not coupled to each other, the present invention is not limited thereto. For example, a surface modification portion similar to that of the first embodiment may be formed on the edge portion of each lens element of the second embodiment. When each lens element is sequentially housed in the lens barrel, the lens element housed immediately prior may be pressed such that the lens elements are bonded to each other. In addition, all of the lens elements may be coupled with each other, or only some of the lens elements that are optically sensitive (susceptible to positional deviation) may be bonded from among the plurality of lens elements.

In the first embodiment and the second embodiment, all the lens elements have a configuration in which a conical inclined surface is formed on the edge portion, and positioning in the radial direction and the optical axis direction can be performed by the ring plane.

However, in the case that a lens element with high misalignment sensitivity is used, for example, alignment may be necessary. In this case, by making the edge portions of a lens element and its adjacent lens units into a shape without a conical inclined surface, a configuration may be used in which the lens elements may be movable in directions perpendicular to the optical axis, and the lenses may be pressed and bonded after performing the alignment step.

In addition, in each of the embodiments described above, although a heating step is included in the manufacturing method, the heating step may be omitted as long as sufficient bonding strength can be achieved by pressing alone. Also, as long as sufficient bonding strength can be achieved by abutting of the surface modification portions, pressing is not necessary.

Although the embodiments of the present invention have been described above, the present invention is not limited to these examples. Additions, deletions, and design changes made to the constituent elements by one skilled in the art with respect to the above-described embodiments are also included within the scope of the present invention, provided there are in the spirit of the present invention.

### REFERENCE SIGNS LIST

1, 1A Imaging lens unit
2, 2A Lens barrel
3, 3A Peripheral Wall Portion
3a, 3c Inner circumferential surface
3b Rib
4 Front wall portion
4a Opening
4b Receiving surface
6 Rear light shielding ring
6a Outer circumferential surface
7 Lens assembly
8, 9 Surface modification portion
10 First lens element
20 Second lens element
30 Third lens element
40 Fourth lens element
50 Fifth lens element
11, 21, 31, 41, 51 Lens portion
12, 22, 32, 42, 52 Edge portion
13 Contact surface
23, 33, 43, 53 Annular Step Portion
14, 24, 34, 44, 54 Annular Step Portion
23a, 33a, 43a, 53a Conical inclined surface
14a, 24a, 34a, 44a, 54a Conical inclined surface
23b, 33b, 43b, 53b Ring plane
14b, 24b, 34b, 44b, 54b Ring plane
55 Outer circumferential surface
16, 26, 36, 46, 56 Anti-reflection film
17, 27, 37, 47, 57 Surface Modification Portion
63 Annular Corner Portion
63a Conical inclined surface
63b Ring Plane
60 Light shielding plate
P Optical axis
C Coating region
NC Non-coating region
F Infrared cut filter
S Imaging sensor

1. An imaging lens unit comprising:
a lens barrel formed of a resin material; and
a plurality of lens elements formed of a resin material and housed in the lens barrel, wherein
each of the plurality of lens elements includes a lens portion and an edge portion around the lens portion,
a surface modification portion is formed by irradiation of vacuum ultraviolet light on the edge portion, and
adjacent lens elements of the plurality of lens elements are bonded at the surface modification portion.

2. The imaging lens unit according to claim 1,
wherein the lens barrel includes, in contact with the edge portion of the lens element of the plurality of lens elements disposed closest to an object side, a receiving surface orthogonal to an optical axis and a cylindrical inner circumferential surface extending in an optical axis direction;
a surface modification portion is formed by irradiation of vacuum ultraviolet light on the receiving surface and the inner circumferential surface; and
the edge portion of the lens element of the plurality of lens elements disposed closest to the object side and the receiving surface of the lens barrel are bonded at the surface modification portions.

3. The imaging lens unit according to claim 1, wherein the surface modification portions are pressed and bonded to each other.

4. The imaging lens unit according to claim 2, wherein
a surface modification portion is formed by irradiation of vacuum ultraviolet light on an outer circumferential surface of the edge portion of the lens element of the plurality of lens elements disposed closest to an image side; and
the outer circumferential surface of the edge portion of the lens element of the plurality of lens elements disposed closest to the image side and the lens barrel are bonded together by press fitting.

5. The imaging lens unit according to claim 1, wherein
abutting portions abutting adjacent lens elements of the plurality of lens elements are formed on the edge portions of the plurality of lens elements; and
the surface modification portions are formed at least on the abutting portions.

6. The imaging lens unit according to claim 5, wherein the abutting portions are pressed and bonded.

7. The imaging lens unit according to claim 2 or 5, further comprising
closest to an image side of the lens barrel, an annular fixing member formed of a resin material for fixing the plurality of lens elements, wherein
a surface modification portion formed by irradiation of vacuum ultraviolet light is formed on an outer circumferential surface of the annular fixing member; and
the outer circumferential surface of the annular fixing member and the inner circumferential surface of the lens barrel are bonded by press fitting.

8. A method of manufacturing an imaging lens unit that includes
a lens barrel formed of a resin material, and
a plurality of lens elements formed of a resin material and housed in the lens barrel, each of the plurality of lens elements including a lens portion and an edge portion around the lens portion;
the method comprising:
a surface modification step of irradiating the edge portions of the plurality of lens element with vacuum ultraviolet light to form surface modification portions; and
a bonding step of pressing the surface modification portions to bond the plurality of lens elements together.

9. The method of manufacturing the imaging lens unit according to claim 8, wherein
the lens barrel includes, in contact with the edge portion of the lens element of the plurality of lens elements disposed closest to an object side, a receiving surface orthogonal to an optical axis and a cylindrical inner circumferential surface extending in an optical axis direction; and
the method further comprises
a surface modification step of irradiating vacuum ultraviolet light on the receiving surface and the inner circumferential surface to form a surface modification portion; and
a bonding step of pressing the edge portion of the lens element of the plurality of lens elements disposed closest to the object side and the receiving surface of the lens barrel to bond the surface modification portions together.

10. The method of manufacturing the imaging lens unit according to claim 9, wherein the bonding step further includes
a surface modification step of forming, by irradiating vacuum ultraviolet light on an outer circumferential surface of the edge portion of the lens element of the plurality of lens elements disposed closest to the image side, a surface modification portion; and
a bonding step of pressing and bonding the outer circumferential surface of the edge portion of the lens element of the plurality of lens elements disposed closest to the image side to the inner circumferential surface of the lens barrel by press fitting.

11. The method of manufacturing the imaging lens unit according to claim 9, wherein
the imaging lens unit further includes, closest to the image side of the lens barrel, an annular fixing member formed of a resin material for fixing the plurality of lens elements; and
the method further comprises
a surface modification step of forming, by irradiating vacuum ultraviolet light on an outer circumferential surface of the annular fixing member, a surface modification portion; and
a bonding step of pressing and bonding the annular fixing member inside the lens barrel by press fitting.

12. The method of manufacturing the imaging lens unit according to claim 8, further comprising a heating step of heating the surface modification portions prior to the surface modification step.

13. The method of manufacturing the imaging lens unit according to claim 8, further comprising a heating step of heating the surface modification portions between the surface modification step and the bonding step.

14. The method of manufacturing the imaging lens unit according to claim 8, wherein the bonding step further includes a heating step of heating the surface modification portions.
